(19) United States
(12) Patent Application Publication
(10) Pub. No.: US 2004/0231930 A1
(43) Pub. Date: Nov. 25, 2004

(54) Multiple-function elevator cross-head

(76) Inventors: Patrick Bass, Lakeside, CA (US); Aranggi Soemardjan, El Cajon, CA (US)

Correspondence Address: WHITE & CASE LLP, PATENT DEPARTMENT, 1155 AVENUE OF THE AMERICAS, NEW YORK, NY, 10036, US

(21) Appl. No.: 10/769,391

(22) Filed: Jan. 30, 2004

Related U.S. Application Data
(63) Continuation-in-part of application No. 10/353,173, filed on Jan. 28, 2003.

(51) Int. Cl. B66B 7/02

(52) U.S. Cl. 187/406

(57) ABSTRACT

A multiple function cross-head for an elevator is horizontally disposed at the upper ends of two vertical stiles that form an elevator car frame. The cross-head supports a door header, door hanger assembly, door operator assembly, and a cross-beam. The cross-beam supports a sheave assembly which engages a rope in an elevator system to raise and lower the elevator car in a shaftway.

### CROSS-REFERENCE TO RELATED APPLICATIONS

This application is a continuation-in-part of U.S. patent application Ser. No. 10/353,173, filed Jan. 28, 2003, which is incorporated by reference herein in its entirety.

### FIELD OF THE INVENTION

The present invention is directed to the field of elevator systems. More particularly, the present invention is directed to an integrated door header forming a multiple-function elevator cross-head.

### BACKGROUND OF THE INVENTION

Elevator systems typically include an elevator car, an elevator door, and a door operator for opening and closing the door to the car. A conventional roped elevator system is shown schematically in FIG. 1.

FIG. 1 shows a car 10 supported by a sling 20. The car stops at a number of landings 40. The car rests on a platform 45 which is supported by the sling 20. The car 10 is guided by a pair of guide rails 50 (one of which is shown) on opposite sides of the car. A pair of sheaves 60 and 65 are rotatably mounted above the cab on a pair of horizontal shafts 63 and 67. The shafts are supported by overhead support beams (not shown). One end of a hoist rope 69 is mounted to the sling substantially at the midpoint of the crosshead 25, corresponding to the center of mass of the elevator car. The other end of the rope is attached to a counterweight in the hoistway (not shown). The car is driven by the rope 69, which passes around and is guided by sheaves 60 and 65.

Sliding elevator doors or panels 70 are usually hung on a door hanger 80 which comprises a rolling assembly 85 fastened to the top of each of the door panels. The rolling assembly 85 supports and allows horizontal sliding movement of the doors 70, and is actuated by a door operator. A track 87, upon which the door hanger 80 rolls, is part of the door hanger assembly.

A door header 90 (shown in partial cross-section) serves as a structural part of the frame to support the door hanger 80 and vertical struts or stiles 95. Thus, sling 20, cross member 25, vertical stiles 95, and door header 90 separately support the structure of the elevator cab and the other components. A roped hydraulic elevator having these components is illustrated in U.S. Pat. No. 6,085,872.

Multiple weight-bearing and structural components in the elevator cab add weight to the elevator system. It would be desirable to reduce the number of separate elements forming the elevator system in order to simplify the construction of the elevator, and to reduce the weight of the cab.

### SUMMARY OF THE INVENTION

The present invention is an improved elevator system in which the functions of the sling, cross-head, and door header have been combined into an integrated cross-head. The inventive cross-head provides structural integrity to the elevator car, as well as a suitable location for the door operator and the door hanger. Thus, these structural and functional components of the elevator car are combined integrally at one location near the door in a compact manner. The cross-head can be used in conjunction with the triangulated elevator support structure described in co-pending U.S. patent application Ser. No. 10/353,173, filed Jan. 28, 2003, which is incorporated herein by reference.

In an embodiment of the present invention, a three-function cross-head supports a sling of an elevator car. The cross-head comprises a header member horizontally disposed at the upper ends of two vertical stiles located near the entryway to the cab. The header supports a door hanger assembly for supporting one or more sliding elevator doors. The header also supports a door operator assembly for driving the one or more elevator doors between an opened and a closed position. A portion of the cross-head can also serve as a pick-point for hoisting the elevator cab. For example, a beam supporting a sheave assembly can be connected to the header. One end of the beam is connected to the header, and the other end includes one or more elements comprising the sheave assembly. The sheave, beam and header move vertically in unison.

In another embodiment of the invention, a three-function cross-head has a member horizontally disposed at the upper ends of two vertical styles. An elevator tension member, such as an elevator drive rope, is affixed to the header.

### BRIEF DESCRIPTION OF THE DRAWINGS

FIG. 1 shows a conventional elevator system, in which a door header, door operator, and a sling having a cross-member are present as separate elements.

FIG. 2 shows an embodiment of an elevator car system according to the present invention, in which a diagonal sling is attached to a multi-function cross-head.

FIG. 3 illustrates an exemplary embodiment of the invention.

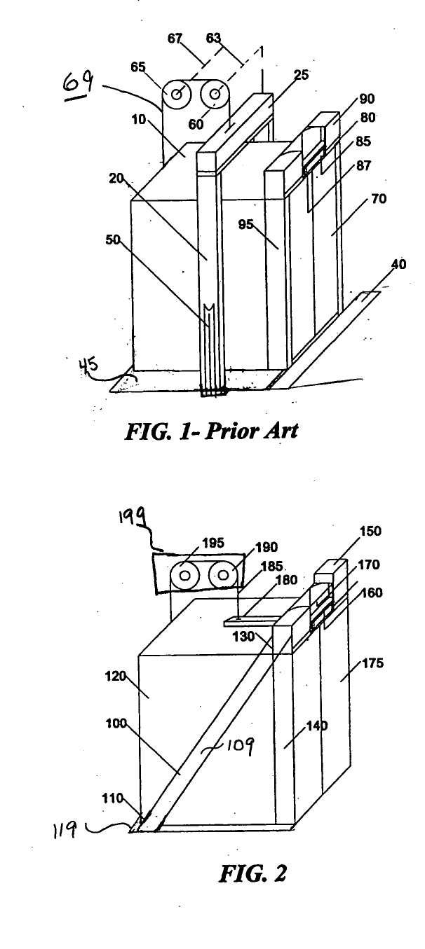

### DETAILED DESCRIPTION OF THE INVENTION

Exemplary embodiments of the invention will now be described with reference to the Figures, wherein like reference numerals correspond to like elements. The expressions “multi-function cross-head” and “three-function cross-head” both refer to the inventive cross-head described in this specification.

In the figures, the new cross-head has been shown as having a center-opening door. Nevertheless, any kind of sliding door can be used with the present invention. For example, the doors can be single-speed doors, double-speed doors, side-opening doors, or any other kind of sliding elevator doors. In addition, the doors can be swinging elevator doors.

FIG. 2 illustrates an embodiment of the invention comprising the inventive multi-function cross-head 150 as part of a diagonal sling 100. The cross-head 150 has a horizontal member disposed at the upper ends of two vertical stiles 140 (only one of which is shown). The cross-head 150 supports a door header, door hanger assembly 160, door operator assembly 170, and a cross-beam 180 that is connected to a sheave assembly 199 for moving the elevator car 120 vertically.

Sling 100 comprises two diagonal braces 109 on opposite sides of the elevator car 120 (only one brace is visible in the Figures). One end 110 of the brace 109 is secured to one section of the platform 119. The other end 130 of the brace 109 is affixed to a diagonally opposite section of the crosshead 150. Stiles 140 are fastened to cross-head 150 on opposite sides of the cab 120 to form the vertical members of a car frame. The cross-head 150 serves as a door header and supports the door hanger assembly 160 and the door operator 170.

Door panels 175 are hung on the door hanger, and door operator 170 drives the elevator doors to between an opened and a closed position. One end of a cross-beam 180 is attached to the cross-head 150. A sheave assembly 199 is mounted to the second end of the cross-beam 180 and drives the elevator rope or tension member 185. The sheave assembly comprises any number of sheaves, such as 190 and 195. The elevator rope 185 is connected to a counter-weight (not illustrated) and to beam 180. A motor moves the rope 180 and in turn moves the car 120 up or down.

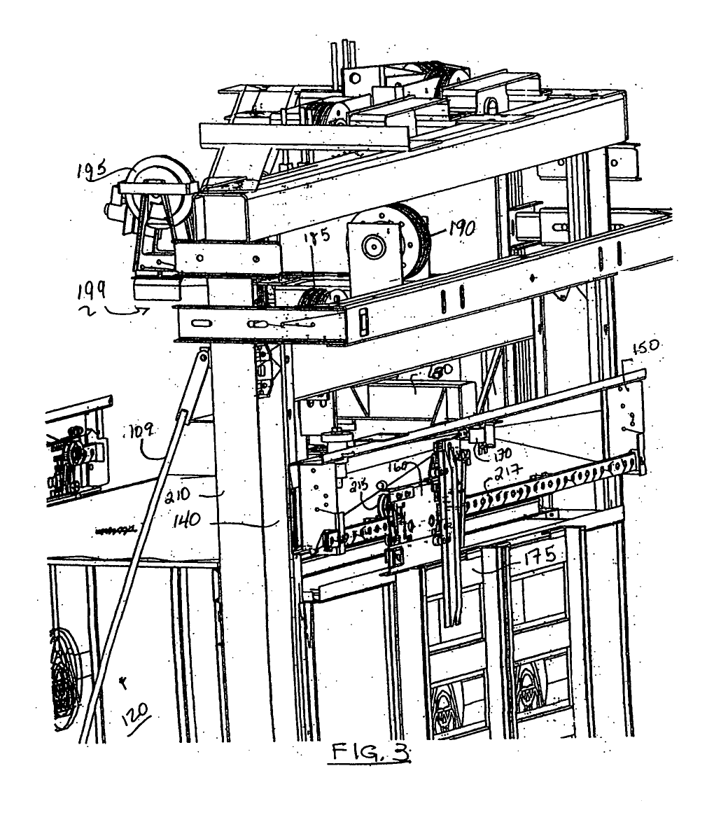

FIG. 3 illustrates an exemplary embodiment of the cross-head. The cross-head 150 serves several functions, including housing a door header, a door hanger 160, and a door operator 170. Elevator doors or panels 175 are hung on door hanger 160. The door hanger 160 comprises rolling assembly 215 fastened to the top side of the door panel 175. Track 217, on which the hanger rolls, is part of the door hanger 160. The rolling assembly 215 is actuated by the door operator 170 which is mounted on the same cross-head 150. The door operator 170 comprises a motor driven device for opening and closing the door panels 175.

The cross-head also serves as a pick-point for attaching the car to the rope 180. The cross-head 150 is fastened to stiles 140 on opposite sides of the car 120. The stiles 140 form vertical members of a frame that supports the elevator car 120. Diagonal brace 109 forms a part of the sling for supporting the cab. Car 120 is guided by a pair of guide rails 210 on opposite sides of the car 120. One end of beam 180 is fastened to a stabilizing point on the cross-head 150, and elevator rope 185 is secured to the other end of the beam 180. The rope 185 wraps around sheave assembly (shown generally as 199). The sheave assembly comprises a plurality of rotatable sheaves. The sheaves, e.g. 190 and 195, communicate with the other sheaves of the assembly through rope 185. The rope 185 moves the sheave assembly 199, the beam 180, and the integrated cross-head 150, and thereby the elevator car, vertically in unison.

While the invention has been shown and described with reference to particular embodiments, those skilled in the art will understand that various changes in form and details may be made without departing from the spirit and scope of the invention.

What is claimed is:

1. A multiple function cross-head for an elevator sling supporting an elevator car, the cross-head comprising a header, the header comprising:
a) a door hanger assembly for supporting one or more slidable elevator door panels;
b) a door operator assembly for driving the one or more elevator doors panels to between an opened position and a closed positions; and
c) a pick-point for connecting the elevator car to a rope of an elevator system.

2. The cross-head according to claim 1, wherein the pick-point comprises a cross-beam affixed to the header, the cross-beam for mounting a sheave assembly.

3. The cross-head according to claim 1, wherein the header is horizontally disposed at the upper ends of two stiles, the stiles forming vertical members of the elevator sling.

4. The cross-head according to claim 1, wherein the elevator sling further comprises a diagonal brace extending from a platform of the sling to a diagonally opposite section of the cross-head.

5. The cross-head according to claim 1, wherein the door hanger comprises a rolling assembly and a track upon which one or more door panels slide laterally.

6. The cross-head according to claim 1, wherein the door operator comprises a motor driven device for opening and closing the door panels.

7. The cross-head according to claim 2, wherein one end of the cross-beam is located substantially over a center of mass of the elevator car.

8. An elevator system comprising the cross-head according to claim 1.
